(19) United States
(12) Patent Application Publication
(10) Pub. No.: US 2011/0014485 A1
(43) Pub. Date: Jan. 20, 2011

(54) Solar Control Film

(76) Inventors: Stephen S. Wilson, Las Vegas, NV (US); Bart Wilson, Las Vegas, NV (US); Seth Wilson, Las Vegas, NV (US)

Correspondence Address: STETINA BRUNDA GARRED & BRUCKER, 75 ENTERPRISE, SUITE 250, ALISO VIEJO, CA, 92656, US

(21) Appl. No.: 12/503,555

(22) Filed: Jul. 15, 2009

(51) Int. Cl. B32B 15/09

(52) U.S. Cl. 428/458

(57) ABSTRACT

An enclosure having a high efficiency solar control system is provided. The enclosure may have a transparent or opaque base layer and a film mounted to its exterior side. The film may reflect solar radiation in the near and mid infrared ranges yet allow high transmission of light in the visible range. The film may have a layer of silver which reflects the solar radiation in the near and mid infrared ranges. Since the silver is susceptible to oxidation and turns the silver into a black body which absorbs the near and mid infrared radiation, the film may be designed to slow the rate of oxidation of the silver layer to an acceptable level. The silver layer may be sandwiched between the base layer which may not allow oxygen to diffuse there through and reach the layer of silver and a stack of sacrificial layers having a certain thickness which slows down the rate of oxygen diffusion to an acceptable level.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a solar control film that reflects infrared radiation and allows the visible range of light to be transmitted through the solar control film to reduce a solar infrared radiation load on an enclosure.

Many different types of enclosures are exposed to the sun's rays. By way of example and not limitation, these enclosures include homes, commercial buildings, boats, cars, cabins, etc. and other plethora of other types of enclosures for human use as well as use in which a controlled interior environment may be desired or required (e.g., temperature sensitive remote test labs, box, etc.). When the internal temperature of the enclosure needs to be cooler than the outside ambient temperature, reducing the solar load on the enclosure is desirable to reduce the energy requirement to maintain the interior temperature of the enclosure at the desired temperature below the ambient temperature. As a result, direct sunlight on the enclosure may require use of the air conditioning system and/or use the air conditioning system at a higher level than necessary. This may be especially true when the sun's ray's enter the enclosure through a transparent panel (e.g., window) or even opaque panel which may be transparent to the infrared wavelengths of the sun's rays. Conversely, when the internal temperature of the enclosure needs to be warmer than the outside ambient temperature (e.g., winter), it may be desirable to retain thermal radiation emanating from within the enclosure to reduce the heating requirement. As a result, the heating system may be turned on to bring the internal temperature of the enclosure above the outside ambient temperature.

Unfortunately, the air conditioning system and heating system may consume a large percentage of energy expended by the enclosure (e.g., facility, automobile, boat, home, building, etc.) in light of its overall energy consumption. As such, reducing the cooling and heating needs may reduce total energy consumption.

When humans are inside the enclosure and the need to feel cool is important, several factors determine the comfort level within the enclosure (e.g., home, etc.). They include the air temperature, air speed within the enclosure, humidity of the air within the enclosure and the amount of thermal radiation entering the enclosure. When the air temperature is uncomfortably hot, the occupants may turn on the air conditioning system to cool down the average air temperature. In this instance, the air conditioning unit consumes energy to reduce the air temperature within the enclosure. The occupants may also turn on and/or increase fan speed to increase air speed of the air circulating within the enclosure. The fan consumes energy. The speed of air within the enclosure increases evaporation of moisture on the skin of the occupants which cools the occupant's skin temperature.

During the day, the enclosure may be exposed to solar radiation. A portion of the solar radiation may be absorbed by a window (i.e., transparent panel), a wall or body panel (i.e., opaque panel) of the enclosure and heated. The absorbed solar radiation may be converted into heat and re-radiated into the interior of the enclosure thereby increasing the enclosure's air temperature and heat up the interior of the enclosure. A portion of the solar radiation is transmitted through the transparent panel and absorbed by the interior of the enclosure(e.g., auto dashboard, furniture upholstery, equipment, etc.). Upon absorption, the interior of the enclosure re-radiates the absorbed energy as thermal radiation into the air within the enclosure. This further increases the air temperature within the enclosure. The hot air and the hot interior of the enclosure re-radiates energy generally as infrared radiation in the mid infrared range. Unfortunately, certain transparent panels (e.g., automotive glass windows) generally do not allow the mid infrared radiation to escape therethrough back into the environment. Also, many opaque panels (e.g., walls, metallic panels, etc.) do not allow the mid infrared radiation to escape therethrough back out to the environment. As such, the mid infrared radiation is retained within the enclosure and increases a temperature of the enclosure above ambient temperature.

A portion of the solar radiation transmitted through the transparent panel may also be absorbed by the occupant's skin. This portion of the sun's rays may cause the occupants to feel uncomfortably hot thereby encouraging use of the air conditioning system even if the enclosure's air temperature is within a comfortable range. This may cause the occupant to turn on the air conditioning system and/or fan. Use of the air conditioning system and the fan both consume energy. Any reduction in the use of the air conditioning system and fan would also reduce the total amount of energy consumed.

The human skin contains receptors that are sensitive to thermal radiation in the infrared range. When the occupants of the enclosure are exposed to infrared radiation, the occupants may be uncomfortable even if the enclosure air temperature is within a comfortable range. The occupants may resort to decreasing the average air temperature of the enclosure and increasing the air speed of the fan system to counteract the discomfort caused by thermal radiation, both of which consume increasing amounts of energy.

As such, there is a need in the art for an apparatus and method for reducing the need to use the air conditioning system and/or fan and reducing occupant exposure to solar infrared radiation. Also, there is a need in the art for an apparatus and method for reducing the need to use the heating system.

### BRIEF SUMMARY

The present invention addresses the needs discussed above, discussed below and those that are known in the art.

A high efficiency solar control system is disclosed. The solar control system may comprise a base layer (e.g., wall, auto body, glass window) and a film mounted to its exterior side, namely, the side closer to the environment. The base layer may be part of the enclosure and may be exposed to direct solar radiation. The film may have high transmission of light in the visible range. Also, the film may reflect a high percentage of light in the near infrared range and the mid infrared range back into the environment. As such, the solar load on the enclosure may be reduced by the amount of solar radiation in the near infrared range and the mid infrared range reflected back into the environment.

The film may additionally have a plurality of sacrificial layers which have a high transmission value with respect to the visible range and the near and mid infrared ranges. The topmost sacrificial layer may be removed or peeled away when it has been unacceptably degraded due to environmental elements (e.g., chips, oxidation, etc.) thereby exposing a fresh new topmost layer. Additionally, the additional sacrificial layers mitigate oxidation of a silver layer embedded within the film. In particular, the film is mounted to the base layer which typically does not allow oxygen to be diffused therethrough. As such, one side of the film does not allow diffusion of oxygen into the film since oxygen cannot diffuse through the base layer. On the other side of the film (or the silver layer(s)), a thick stack of sacrificial layers may be formed. Although oxygen may be diffused through the sacrificial layers, such diffusion of oxygen through the sacrificial layers may be slowed down by increasing the thickness of the sacrificial layers. Either or both the number of sacrificial layers may be increased or decreased as appropriate or the thickness of each of the sacrificial layers may be increased or decreased to bring the rate of oxygen diffusion to an acceptable level. The silver layer is disposed between the base layer and the thick stack of sacrificial layers which protects the silver layer from oxidation.

When the film is adhered to the exterior surface of a transparent panel (e.g., window) of an enclosure (e.g., home), the film may retain infrared radiation in the near and mid infrared ranges within the enclosure that emanate from within the enclosure. This may be beneficial during the winter months when the inside temperature of the enclosure is preferably warmer than the ambient outside temperature. The film may be adhered to the transparent panel so as to have a layer of gas (e.g., argon, krypton, dehumidified air, etc.) between the film and the transparent panel so as to provide an additional layer of thermal insulation to retain heat within the enclosure.

A solar control film for reflecting solar infrared radiation to reduce solar infrared radiation load on an enclosure is disclosed. The solar control film may comprise an infrared reflecting layer and one or more protective layers. The infrared reflecting layer may define an interior side and an exterior side. The interior side of the infrared reflecting layer may be attachable to an exterior of the enclosure. The infrared reflecting layer may have an embedded infrared reflecting core which comprises one or more layers of silver and one or more layers of dielectric for reflecting solar infrared radiation. The silver and dielectric layers may alternate. The one or more protective layers may be removeably attached to the exterior side of the infrared reflecting layer for mitigating oxidation of the silver layer and for providing a sacrificial top layer which can be removed when the top protective layer is damaged due to ultraviolet light exposure or oxidation.

The solar control film may further comprise an adhesive layer disposed between the infrared reflecting layer and the enclosure for adhering the film to the enclosure. The adhesive may be an ultraviolet light absorbing adhesive. The protective layer may be generally transparent to visible wavelengths of light. The protective layer may be fabricated from biaxially-oriented polyethelene terephthalate. The protective layers may be peelably adhered to one another. An exterior side of each of the protective layers may have an ultraviolet light absorbing hard coat. The one or more protective layers may be sufficiently thick to reduce the rate of oxidation of the silver layer to a level such that the film has a sufficiently useful long life. The one or more protective layers may be fabricated from biaxially-oriented polyethelene terephthalate.

A solar control film for reflecting solar infrared radiation to reduce solar infrared radiation load on an enclosure is disclosed. The solar control film may comprise an infrared reflecting core, a first protective layer and a second protective layer. The infrared reflecting core may comprise one or more layers of silver and one or more layers of dielectric for reflecting infrared radiation. The infrared reflecting core may define opposed first and second sides.

The first protective layer may be attached to the first side of the infrared reflecting layer. The first protective layer may have a first thickness. The second protective layer may be attached to the second side of the infrared reflecting layer and attachable to the enclosure. The second protective layer may have a second thickness. The first thickness may be greater than the second thickness.

The first and second protective layers provide structural support to the one or more silver layers. The thicker first protective layer mitigates oxidation of the one or more silver layers caused by oxygen diffusion through the first protective layer. The solar control film may further comprise a stack of sacrificial layers attached to the first protective layer. The stack of sacrificial layers may be removeably attached to each other such that a top most protective layer may be removed and discarded when the top most sacrificial layer is damaged due to ultraviolet light exposure or oxidation. The sacrificial layers may be peelably adhered to each other.

The first thickness may be sufficiently thick to reduce the rate of oxidation of the silver layer to a level such that the film has a sufficiently long useful life.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 illustrates an enclosure having a high efficiency solar control film disposed on a transparent base layer and an opaque base layer;

FIG. 2 is a cross sectional view of the transparent base layer shown in FIG. 1;

FIG. 2A is a cross sectional view of a prior art transparent base layer without an absorption film;

FIG. 2B is a cross sectional view of the prior art transparent base layer with an absorption film;

FIG. 3 is an enlarged view of the transparent base layer with film shown in FIG. 2;

FIG. 4 is an enlarged view of an alternate embodiment of the film shown in FIG. 3;

FIG. 5 illustrates thermal radiation emanating from within the enclosure shown in FIG. 1 being reflected back to the interior of the enclosure by the film attached to a transparent base layer;

FIG. 6 is a cross sectional view of the opaque base layer shown in FIG. 1; and

FIG. 6A is a cross sectional view of a prior art opaque base layer.

### DETAILED DESCRIPTION

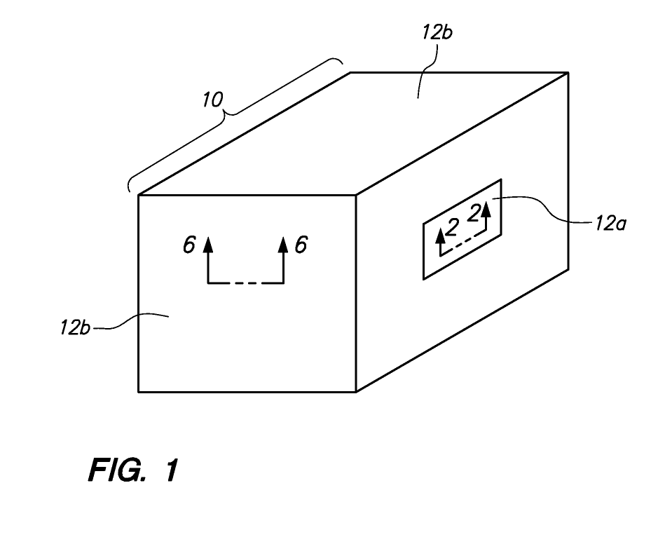

Referring now to FIG. 1, an enclosure 10 (e.g., home, office building, boat, automobile, etc.) having a base layer 12a, b is shown. The base layer 12a, b may be a window, building wall, etc. that is exposed to direct solar radiation. It is also contemplated that the base layer 12a, b may be a surface which is exposed to infrared radiation. The transparent base layers 12a may serve to protect occupants or objects within the enclosure from environmental elements (e.g., wind, rain, etc.) yet allow the occupants to view the surroundings from within the enclosure 10 or allows observers to view the objects within the enclosure 10. The opaque base layers 12b may also serve to protect occupants or objects from environmental elements (e.g., wind, rain, etc.).

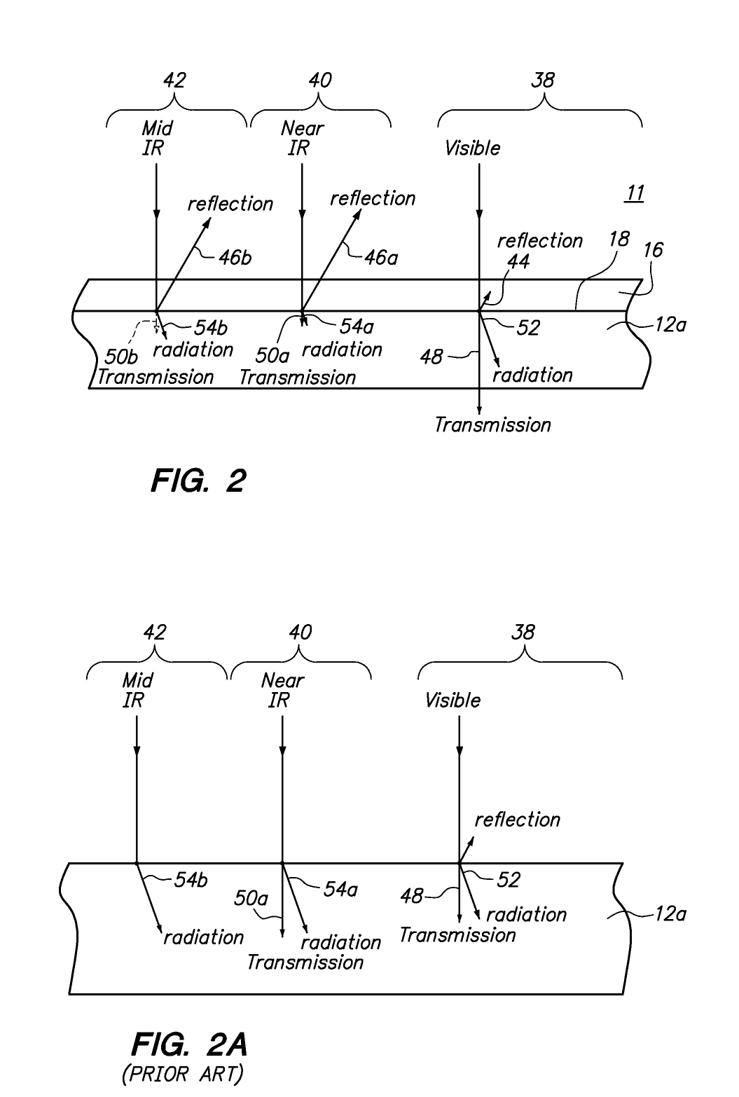

As shown in FIG. 2, the transparent base layer 12a have a film 16 attached to an exterior side 18 of the transparent base layer 12a. The film 16 may be generally optically transparent in the visible wavelengths and generally reflect radiation in the non-visible or infrared wavelengths. The sun's rays transmit solar radiation both in the visible light range and also in the infrared range. A majority of the radiation in the infrared range may be reflected back to the exterior 11 of the enclosure 10 by the film 16. A small portion of the energy may be transmitted into the enclosure through the transparent base layer 12a and a small portion may be absorbed by the transparent base layer 12a, converted into heat and re-radiated into the interior 13 of the enclosure. Beneficially, the film 16 reduces the amount of solar radiation in the near and mid infrared ranges from entering into the enclosure by reflecting a large percentage back to the environment. As such, the amount of solar radiation introduced into the enclosure 10, absorbed into the interior of the enclosure 10 and contacting the skin of any occupants within the enclosure 10 is reduced. This lowers the average air temperature within the enclosure 10. This also reduces discomfort of any occupants in the enclosure due to exposure to infrared radiation when the occupant is in the line of sight of the sun. Beneficially, the film 16 increases the occupant's comfort with respect to temperature. Also, the film 16 reduces the load on the enclosure's cooling system.

As shown in FIG. 2, solar radiation may be divided into the visible range 38, near infrared range 40, and the mid-infrared range 42. For each of these ranges 38, 40, 42, a portion of the solar radiation may be transmitted through the film 16 and a portion of the solar radiation is reflected back to the exterior 11 of the enclosure 10 as shown by arrows 44, 46a, b. In the visible range 38, a large percentage (i.e., more than 50%, but preferably about 70% or more) of the light is transmitted through the film 16. In contrast, in the near infrared range 40 or the mid infrared range 42, a large percentage (i.e., more than 50% but preferably about 80% or more) of the light is reflected back to the exterior 11 of the enclosure 10. Since the film 16 is mounted to the exterior of the transparent base layer 12a, less of the near infrared radiation 40 and the mid infrared radiation 42 reaches the transparent base layer 12a compared to the prior art as shown by comparing FIG. 2 with FIGS. 2A and 2B. FIG. 2A illustrates an untreated transparent base layer 12a without an absorption film 55. FIG. 2B illustrates the transparent base layer 12a with a commonly used absorption film 55 mounted to the interior or inside of the transparent base layer 12a. The lengths of the lines 54a, b and 50a, b which generally indicates magnitude of transmission and radiation is longer in FIGS. 2A and 2B compared to FIG. 2. As shown, the transparent base layer 12a is heated to a lesser extent and the amount of near IR radiation 40 transmitted through the transparent base layer 12a is less with use of the film 16 mounted to the exterior of the transparent base layer 12a such that the heat load on the enclosure 10 and occupant exposure to near infrared radiation 40 is reduced. This promotes less or no use of the air conditioning system and/or fan of the enclosure 10.

For that portion of the solar radiation transmitted through the film 16, a portion is transmitted through the transparent base layer 12a as shown by arrows 48 and 50a. The remainder is absorbed into the transparent base layer 12a thereby heating the transparent base layer 12a and re-radiating that energy into the interior 13 of the enclosure as shown by arrows 52, 54a, b. Generally for automotive glass, all of mid infrared radiation 42 is absorbed by the transparent base layer 12a (e.g., automobile glass) and reradiated into the interior 13 of the enclosure as shown by arrow 54b. However, it is contemplated that other glass compositions may be employed such that a portion of the mid infrared radiation 42 may be transmitted through the glass 20 as shown by the dash line 50b. The film 16 has a high percentage (i.e., more than 50% but preferably about 70% or more) of transmission 48 of the solar radiation in the visible range 38 and a high percentage (i.e., more than 50% but preferably 80% or more) of reflection 46a, b in the near-infrared range 40 and the mid-infrared range 42. The film 16 also reflects a portion of the solar radiation in the far infrared range (not shown in FIG. 2).

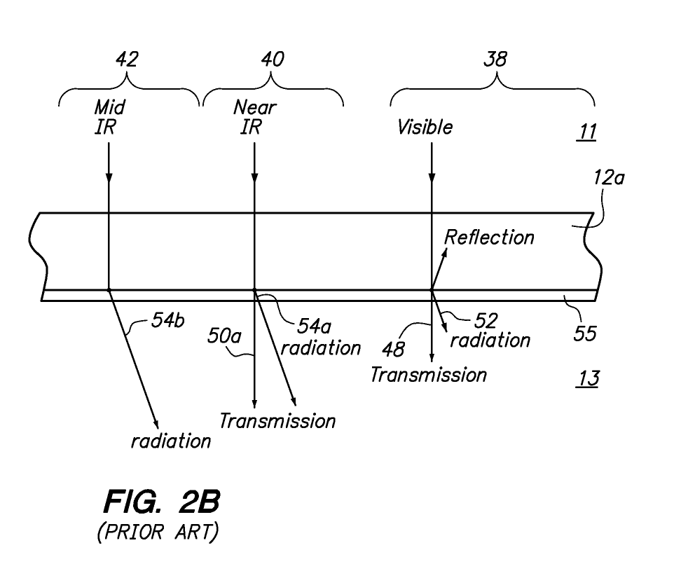

Referring now to FIG. 3, an enlarged cross-sectional view of film 16 and transparent base layer 12a is shown. The film 16 may have an infrared reflecting layer 22 with an embedded infrared reflecting core 24. The infrared reflecting core 24 may comprise one or more silver layers 26 and one or more dielectric layers 28. The silver layer 26 and the dielectric layer 28 may alternate such that the infrared reflecting core 24 may comprise a layer of dielectric 28, a layer of silver 26, a layer of dielectric 28, a layer of silver 26, a layer of dielectric 28 all stacked upon each other. Preferably, the dielectric layers 28 are the outermost layers of the embedded infrared reflecting core 24. At a minimum, one silver layer 26 is disposed between two layers of dielectric 28. The silver layers 26 and dielectric layers 28 may have a thickness measured in nanometers. The silver layer 26 may be generally transparent in the visible range and reflect a high percentage of infrared radiation especially in the near infrared range 40 and the mid infrared range 42. The number and thickness of silver layers 26 and the number and thickness of dielectric layers 28 may be adjusted to tune the amount or percentage of infrared radiation being reflected by the infrared reflecting core 24.

The infrared reflecting core 24 may be sandwiched between two layers 30 of material having high transmission (i.e., greater than 50% but preferably about 90% or more) both in the visible range and the near and mid infrared ranges. By way of example and not limitation, the layer 30 may be biaxially-oriented polyethelene terephthalate (hereinafter “BoPET”) mylar. BoPET is the preferred material since it is dimensionally stable (i.e., not elastic), has a high transmission in the visible and near and mid infrared ranges, low scatter and low cost. The dimensionally stability of the BoPET layer 30 provides support for the silver layer 26. Otherwise, the silver layer 26 may crack or become damaged upon stretching of the layer 30. Additionally, the infrared reflecting layer 22 is useful for reflecting solar thermal radiation in the near and mid infrared ranges 40, 42 and allowing light in the visible range 38 to be transmitted through the BoPET layers 30 and the infrared reflecting core 24.

One of the characteristics of the silver layer 26 is that upon exposure to oxygen, the silver oxidizes as a black material. In the oxidation process, the silver is converted from a material that reflects heat in the near to mid infrared ranges 40, 42 to a black body that absorbs heat in the near to mid infrared ranges 40, 42. Instead of reflecting a majority of the heat in the near and mid infrared ranges 40, 42, the silver layer 26 now absorbs radiation in both the visible range 38 and the near and mid infrared ranges 40, 42. Detrimentally, the silver layer 26 absorbs and re-radiates such energy into the enclosure 10. Additionally, one of the characteristics of the BoPET layer 30 is that oxygen diffuses through the BoPET layer 30 such that oxygen ultimately reaches the silver layer 26 and oxidizes the same 26. To prevent or reduce the rate of oxidation of the silver layers 26 to an acceptable rate, additional layers 30a-d may be stacked on the infrared reflecting layer 22. Any number of layers 30a-n may be stacked on the infrared reflecting layer 22. The amount of oxygen diffused through the layers 30a-n and 30 is a function of a distance 32 from the silver layer 26 and the exterior side 34 of the topmost layer 30. The amount of oxygen reaching the silver layer 26 from an exterior side (i.e., from outside the enclosure 10) is reduced since the oxygen must travel a greater distance through the layers 30a-n and 30. On the interior side, the film 16 is mounted to the transparent base layer 12a which protects the silver layer(s) 26 from oxidation. Oxygen may not pass through the transparent base layer 12a.

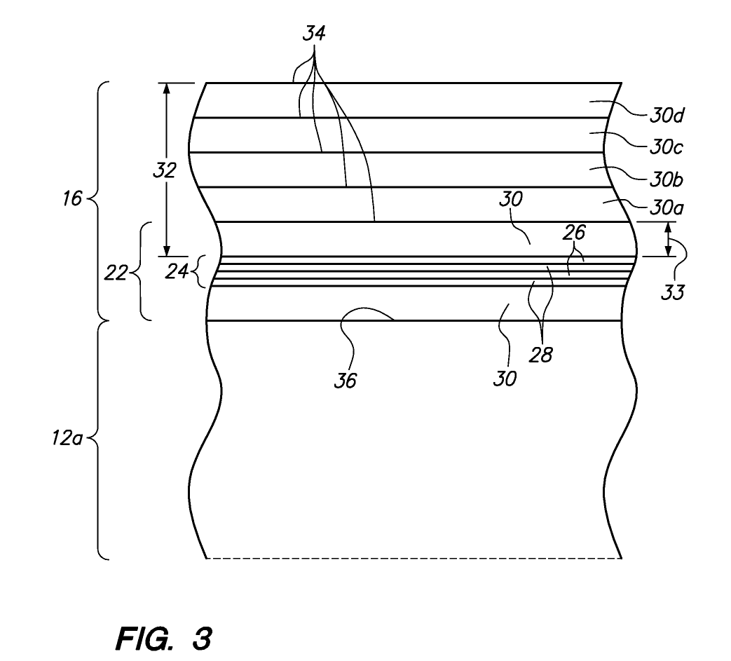

Alternatively, it is contemplated that the thickness 33 of the BoPET layer 30 in the infrared reflecting layer 22 may be increased (see FIG. 4) to slow down the rate of oxidation of the silver layers 26 to an acceptable level. Additionally, an additional stack of BoPET layers 30a-n may be adhered to the BoPET layer 30 on the exterior side, as shown in FIG. 4. The stack of BoPET layers 30a-n may be removably adhered to each other such that the topmost BoPET layer 30a-n may be used as a sacrificial top layer as discussed herein.

Referring back to FIG. 3, during use, the exterior side 34 of the topmost layer 30d is exposed to environmental elements such as rain (containing chemicals), rocks, dirt, ultraviolet light, etc. As such, the exterior side 34 of the topmost layer 30d may experience physical degradation (e.g., chips, oxidation, etc.). It may be difficult to see through the film 16 due to the degradation of the topmost layer 30d. Beneficially, each of the layers 30a-d may be removed (e.g., peeled away) from each other and also from the infrared reflecting layer 22. The then topmost layer behaves as a sacrificial layer which is removed when it has been unacceptably degraded by the environmental elements. To this end, the layer 30d may be peelably adhered to layer 30c, layer 30c may be peelably adhered to layer 30d, layer 30d may be peelably adhered to layer 30a and layer 30a may be peelably adhered to the infrared reflecting layer 22. A tab or other means of removing the topmost layer 30d may be provided such that the topmost layer 30d may be peeled off of the adjacent lower layer 30c when the topmost layer 30d is unacceptably degraded. Upon further use, the new top layer 30c experiences physical degradation. When the then topmost layer 30c is degraded to an unacceptable level, the topmost layer 30c is now peeled away from the top layer 30b. The process is repeated for layers 30b and 30a. As the topmost layers 30d, c, b, a are peeled away, the rate of oxidation of the silver layer 26 increases. As such, the number of layers 30a-n may be increased or decreased based on the required useful life of the film 16. To extend the useful life of the film 16, additional layers 30a-n are stacked upon each other to increase the distance 32. Conversely, to decrease the useful life of the film 16, fewer layers 30a-n are stacked upon each other to decrease the distance 32. When the silver layer 26 is unacceptably oxidized, the entire film 16 is removed from the transparent base layer 12a and a new film 16 is mounted to the exterior surface 36 of the transparent base layer 12a.

Each of the BoPET layers 30a-d and 30 may define an exterior side 34. An ultraviolet light absorbing hard coat may be coated onto the exterior side 34 of the BoPET layers 30a-d and 30 to slow the damaging effects of ultraviolet light on the BoPET layer 30. Additionally, the adhesive for attaching the BoPET layers 30a-d to each other as well as the adhesive for adhering the BoPET layer 30a to the infrared reflecting layer 22 may be an ultraviolet light absorbing adhesive to further slow the damage of ultraviolet light exposure. Such adhesives may continuously cover most if not all of the BoPET layer 30a-d and the infrared reflecting layer 22.

A method for attaching the film 16 to the base layers 12a, b will now be described. Initially, the film 16 is provided. The film 16 may have a peelable protective layer on both sides to protect the silver layers 26 from oxidation and the exterior surfaces from oxidation as well as chipping prior to installation and during storage. The protective layer may be impermeable to oxygen to prevent oxidation of the exterior surfaces of the film 16 as well as oxidation of the silver layers 26. The protective layer may also block ultraviolet light to mitigate damage to the film 16 in the event the film 16 is left out in the sun. The protective layer may be adhered to the exterior surfaces of the film 16 in a peelable fashion. Prior to mounting the film 16 to the base layers 12a, b, the film 16 may be cut to the size of the base layer 12a, b. After the film 16 is cut to size, the protective layers may be peeled away to expose the film 16. The exposed side of the infrared reflecting layer 22 may have a pressure sensitive adhesive that may be activated by water or other fluid. The pressure sensitive adhesive may continuously cover most if not all of the exposed side of the infrared reflecting layer 22. The exterior side of the base layer 12a, b may be wetted down with water or the other fluid. The cut film 16 may now be laid over the exterior side of the base layer 12a, b. Any air bubbles may be squeegeed out. The moist adhesive on the infrared reflecting layer 22 is allowed to dry such that the film 16 is mounted to the base layer 12a, b and the film 16 cannot slip with respect to the base layer 12a, b.

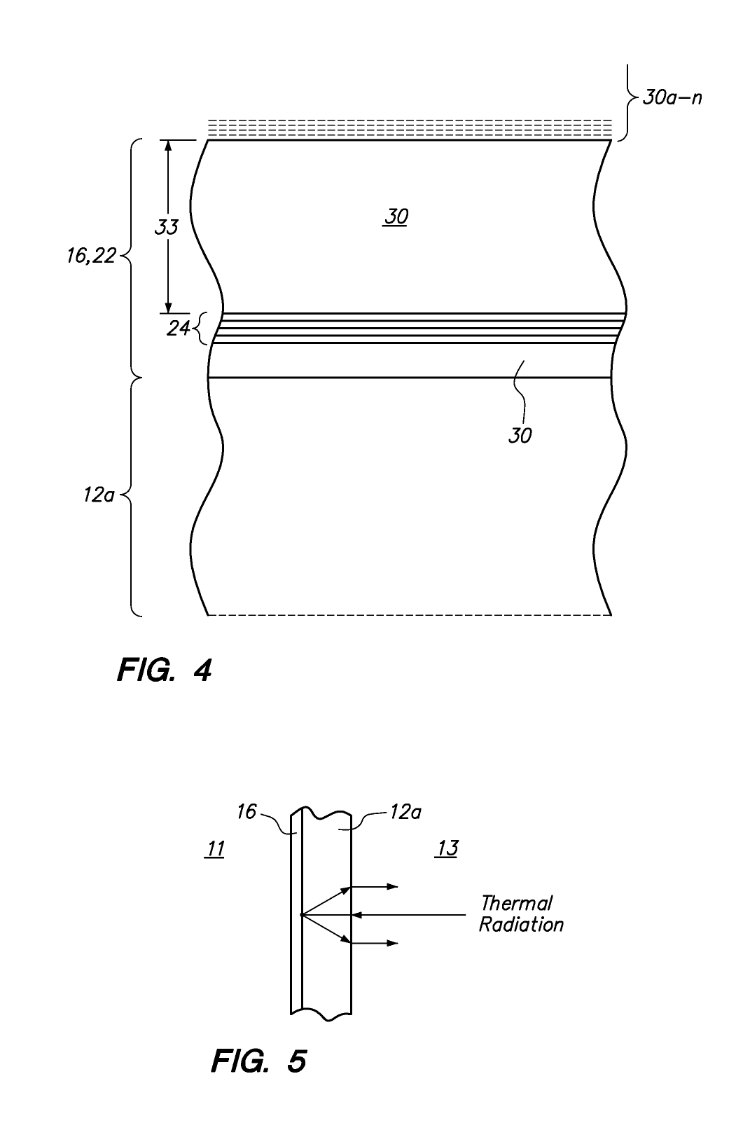

Referring now to FIG. 5, thermal radiation emanates from within an interior of the enclosure 10. The source of the thermal radiation within the enclosure 10 may be the occupant's body heat, a light bulb, stove, heat from objects, etc. Generally, thermal radiation emits infrared radiation in the near, mid and far infrared ranges. A portion of this radiated thermal radiation in the near, mid and far infrared ranges may reach the transparent base layer 12a of the enclosure 10. A portion of the thermal radiation is absorbed by the transparent base layer 12a. A portion of the thermal radiation is transmitted through the transparent base layer 12a and reflected off of the film 16 back toward the interior of the enclosure 10. The film 16 may reflect a majority (i.e., more than 50%, preferably 90%) if not all of the mid and far infrared radiation and approximately 50% of the near infrared radiation. Additionally, the thermal radiation absorbed by the transparent base layer 12a heats the transparent base layer 12a and emits thermal radiation in the near, mid and far infrared ranges toward the exterior 11 of the enclosure as well as the interior 13 of the enclosure 10. For that portion of the thermal radiation transmitted toward the exterior 11 of the building structure 10, the film 16 reflects the thermal radiation in the near, mid and far infrared ranges to re-direct the thermal radiation back into the interior 13 of the enclosure 10. The transparent base layer 12a absorbs the redirected thermal radiation and re-radiates such thermal radiation back into the interior 13 of the enclosure 10. As such, the film 16 retains the thermal radiation emanating from objects and people within the enclosure 10 to reduce the heating needs.

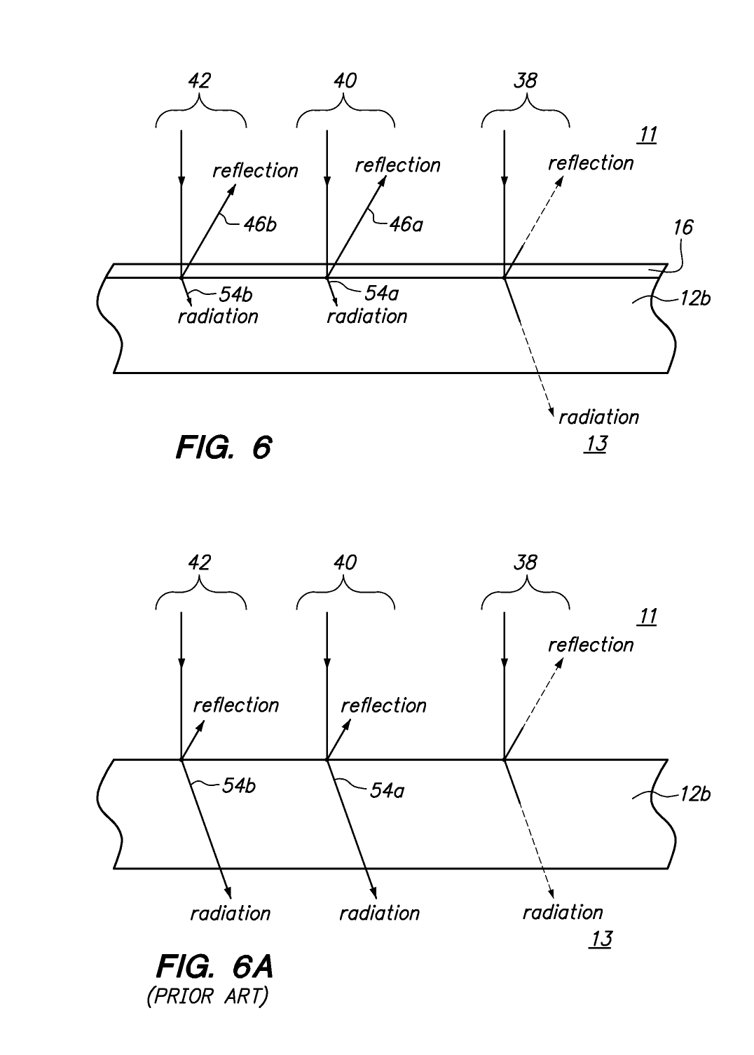

Referring now to FIG. 6, the film 16 may be adhered to an exterior side of an opaque base layer 12b (e.g., wall, roof of an automobile, etc.). The film 16 may serve to reflect a majority of the radiation in the infrared range back to the exterior 11 of the enclosure by the film 16 as shown by lines 46a, b. A small portion of the energy may be absorbed by the opaque base layer 12b, converted into heat and re-radiated into the interior 13 of the enclosure 10 as shown by lines 54a, b. Beneficially, the film 16 reduces the amount of solar radiation in the near and mid infrared ranges from being absorbed by the opaque base layer 12b which is converted into heat and re-radiated into the interior 13 of the enclosure 10. Rather, the film 16 reflects a significant amount of solar radiation in the near and mid infrared ranges back to the environment. As such, the amount of solar radiation load on the enclosure 10 and thermal radiation re-radiated and contacting the occupant's skin is reduced. This lowers the average air temperature within the enclosure 10. This also reduces discomfort of the occupants due to exposure to re-radiated infrared radiation. Beneficially, the film 16 increases the occupant's comfort with respect to temperature.

Referring now to FIG. 6A which is an illustration of a prior art untreated opaque base layer 12b. As can be seen, in the visible range 38, the amount of reflection versus absorption and re-radiation is variable. It is variable based upon the type of material, color and other factors of the opaque base layer 12b. However, in the near and mid infrared ranges 40, 42, more of the radiation is absorbed and re-radiated (see 54a, b)into the interior 13 of the enclosure 10 in the prior art FIG. 6A in comparison to the treated opaque base layer 12b (see FIG. 6). In FIG. 6, a large portion of the near and mid infrared radiation 40, 42 is reflected back to the exterior 11 by the film 16. In contrast, when no film 16 is used as shown in FIG. 6A, a large portion of the near and mid infrared radiation is absorbed by the opaque base layer 12b and re-radiated into the interior 13 of the enclosure 10. Based on the foregoing discussion, the film 16 reduces the solar load on the enclosure 10 since less solar infrared radiation is absorbed by opaque base layers 12b of the enclosure such as walls, etc.

The film 16 may be fabricated in the following manner. Initially, a BoPET layer 30 is provided as a roll. The BoPET layer 30 is unrolled and a layer of dielectric 28 is formed on one side of the BoPET layer 30. The thickness of the BoPET layer 30 may be approximately two thousandths of an inch thick. The thickness of the dielectric layer 28 may be measured in nanometers. As the layer of dielectric 28 is laid on one side of the BoPET layer 30, the BoPET layer 30 is rerolled. The BoPET layer 30 is then unrolled such that a layer of silver 26 may then be laid on top of the layer of dielectric 28. The silver layer 26 is also measured in nanometers and is extremely thin. The BoPET layer 30 is rolled back up and unrolled a number of times until the desired number of silver and dielectric layers 26, 28 is attained. A second BoPET layer 30 (about 0.002 inches thick) may be laminated onto the dielectric layer 28 such that two BoPET layers 30 sandwich the alternating layers of silver 26 and dielectric 28 which form the infrared reflecting core 24. Thereafter, additional layers of BoPET 30a-n (each layer being about 0.002 inches thick) may be laminated onto the infrared reflecting layer 22 to serve as a sacrificial layer and reduce the rate of oxygen diffusion. Optionally, protective layers for protecting the film 16 during storage and prior to installation may be laminated onto opposed sides of the film 16. The thickness of the film 16 may be limited by the amount of bending required to roll the film 16 during manufacture. For thicker films 16, it is contemplated that the film 16 may be fabricated in a sheet form process.

The above description is given by way of example, and not limitation. Given the above disclosure, one skilled in the art could devise variations that are within the scope and spirit of the invention disclosed herein, including various ways of adhering the film 16 to the base layer 12a, b. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A solar control film for reflecting solar infrared radiation to reduce solar infrared radiation load on an enclosure, the solar control film comprising:
an infrared reflecting layer defining an interior side and an exterior side, the interior side of the infrared reflecting layer attachable to an exterior of the enclosure, the infrared reflecting layer having an embedded infrared reflecting core which comprises one or more layers of silver and one or more layers of dielectric for reflecting solar infrared radiation;
one or more protective layers removeably attached to the exterior side of the infrared reflecting layer for mitigating oxidation of the silver layer and for providing a sacrificial top layer which can be removed when the top protective layer is damaged due to ultraviolet light exposure or oxidation.

2. The solar control film of claim 1 further comprising an adhesive layer disposed between the infrared reflecting layer and the enclosure for adhering the film to the enclosure.

3. The solar control film of claim 1 wherein the protective layer is generally transparent to visible wavelengths of light.

4. The solar control film of claim 1 wherein the protective layer is biaxially-oriented polyethelene terephthalate.

5. The solar control film of claim 1 wherein the silver and dielectric layers alternate.

6. The solar control film of claim 1 wherein the protective layers are peelably adhered to one another.

7. The solar control film of claim 1 wherein an exterior side of each of the protective layers has an ultraviolet light absorbing hard coat.

8. The solar control film of claim 2 wherein the adhesive is an ultraviolet light absorbing adhesive.

9. The solar control of claim 1 wherein the one or more protective layers is sufficiently thick to reduce the rate of oxidation of the silver layer to a level such that the film has a sufficiently useful long life.

10. The solar control film of claim 1 wherein the one or more protective layers is fabricated from biaxially-oriented polyethelene terephthalate

11. A solar control film for reflecting solar infrared radiation to reduce solar infrared radiation load on an enclosure, the solar control film comprising:
an infrared reflecting core which comprises one or more layers of silver and one or more layers of dielectric for reflecting infrared radiation, the infrared reflecting core defining opposed first and second sides;
a first protective layer attached to the first side of the infrared reflecting layer, the first protective layer having a first thickness;
a second protective layer attached to the second side of the infrared reflecting layer and attachable to the enclosure, the second protective layer having a second thickness, the first thickness being greater than the second thickness;
wherein the first and second protective layers provide structural support to the one or more silver layers, and the thicker first protective layer mitigates oxidation of the one or more silver layers caused by oxygen diffusion through the first protective layer.

12. The solar control film of claim 11 further comprising a stack of sacrificial layers attached to the first protective layer, the stack of sacrificial layers removeably attached to each other such that a top most protective layer may be removed and discarded when the top most protective layer is damaged due to ultraviolet light exposure or oxidation.

13. The solar control film of claim 14 wherein the sacrificial layers are adhered to each other.

14. The solar control film of claim 13 wherein the first thickness is sufficiently thick to reduce the rate of oxidation of the silver layer to a level such that the film has a sufficiently long useful life.
